(19) United States
(12) Patent Application Publication
(10) Pub. No.: US 2026/0291101 A1
(43) Pub. Date: Sep. 24, 2026

(54) TERMINAL, TERMINAL UNIT AND CONNECTOR

(71) Applicant: Yazaki Corporation, Tokyo (JP)

(72) Inventor: Eiji Aoki, Shizuoka (JP)

(21) Appl. No.: 19/547,936

(22) Filed: Feb. 24, 2026

(30) Foreign Application Priority Data
Mar. 19, 2025 (JP) 2025-044735

(51) Int. Cl. H01R 13/05; H01R 24/40

(52) U.S. Cl. CPC H01R 13/052; H01R 24/40

(57) ABSTRACT

A terminal having a tubular shape, the terminal includes: a plurality of contact portions protruding toward a mating terminal on a tubular surface of the terminal to face the mating terminal The plurality of contact portions are elastically deformable in a protruding direction toward the mating terminal, and include a first contact portion and a second contact portion disposed at different positions in a cylinder axis direction of the terminal.

### CROSS-REFERENCE TO RELATED APPLICATIONS

This application is based upon and claims the benefit of priority from prior Japanese patent application No. 2025-044735 filed on Mar. 19, 2025, the entire contents of which are incorporated herein by reference.

### BACKGROUND

### 1. Field of the Invention

The present disclosure relates to a terminal having a tubular shape, a terminal unit using the terminal as an outer terminal, and a connector using the terminal unit.

### 2. Description of the Related Art

In the related art, there has been proposed a connector including a coaxial electric wire, a tubular outer terminal connected to an outer conductor of the coaxial electric wire, an inner terminal connected to an inner conductor of the coaxial electric wire, an insulator disposed between the outer terminal and the inner terminal, and a housing for accommodating these components (see, for example, JP2022-083728A).

In the connector of the above-described type, to improve reliability of electrical connection between the outer terminal and a mating terminal, it is conceivable to provide a plurality of protrusions on an outer peripheral surface of the outer terminal and bring the protrusions into press contact with the mating terminal. However, for example, when an unintended external force is applied to the electric wire in a state where the outer terminal and the mating terminal are connected, the outer terminal may be displaced to be inclined with respect to the mating terminal due to the external force. In this case, the outer terminal and the mating terminal may not be appropriately electrically connected because some of the plurality of protrusions described above are separated from the mating terminal. Whether the electrical connection between the outer terminal and the mating terminal is appropriate affects a value of an impedance of a conductive path (and therefore a quality of communication via the conductive path). Therefore, it is desired to improve the reliability of the electrical connection between the outer terminal of the connector and the mating terminal.

### SUMMARY

An object of the present disclosure is to provide a terminal excellent in reliability of electrical connection with a mating terminal, a terminal unit using the terminal as an outer terminal, and a connector using the terminal unit.

To achieve the above object, the terminal, the terminal unit, and the connector according to the present disclosure has the following features.

According to a first aspect of the present disclosure, there is provided a terminal having a tubular shape, the terminal including: a plurality of contact portions protruding toward a mating terminal on a tubular surface of the terminal to face the mating terminal, in which the plurality of contact portions are elastically deformable in a protruding direction toward the mating terminal, and include a first contact portion and a second contact portion disposed at different positions in a cylinder axis direction of the terminal.

According to a second aspect of the present disclosure, there is provided a terminal unit including: the terminal according to the first aspect as an outer terminal; an inner terminal disposed in a cylinder of the outer terminal; and an insulator disposed between the outer terminal and the inner terminal

According to a third aspect of the present disclosure, there is provided a connector including: the terminal unit according to the second aspect; a coaxial electric wire electrically connected to the terminal unit; and a housing accommodating the terminal unit.

According to the terminal of the present disclosure, the plurality of contact portions provided in the terminal protrude toward the mating terminal and are in elastically contact with the mating terminal when the terminal and the mating terminal are connected. The plurality of contact portions include the first contact portion and the second contact portion disposed at different positions in the cylinder axis direction of the terminal. That is, the plurality of contact portions are dispersedly disposed in the cylinder axis direction. Accordingly, as compared with a case where all the contact portions are disposed at the same position in the cylinder axis direction, the number of the contact portions maintaining contact with the mating terminal can be increased even when the terminal is inclined with respect to the mating terminal. Specifically, for example, even when the first contact portions disposed on the back side of the mating terminal are separated from the mating terminal, the second contact portions disposed on the front side of the mating terminal are maintained in contact with the mating terminal. As understood from the present description, the tubular surface of the terminal provided with the plurality of contact portions may be an outer tubular surface or an inner tubular surface depending on a positional relationship between the terminal and the mating terminal. In this way, the terminal according to the present disclosure is excellent in reliability of electrical connection with the mating terminal.

As another effect of the terminal according to the present disclosure, since the plurality of contact portions provided in the terminal are dispersedly disposed in the cylinder axis direction, when the terminal is connected to the mating terminal while being brought close to the mating terminal, the respective contact portions sequentially come into contact with the mating terminal. Therefore, it is possible to prevent a rapid increase in a force (a so-called insertion force) required to bring the terminal close to the mating terminal as compared with a case where the plurality of contact portions simultaneously come into contact with the mating terminal. As a result, workability of work of connecting the terminal and the mating terminal can be improved.

According to the terminal unit and the connector of the present disclosure, the plurality of contact portions provided in the outer terminal protrude toward the mating terminal and are in elastically contact with the mating terminal when the outer terminal and the mating terminal are connected. The plurality of contact portions include the first contact portion and the second contact portion disposed at different positions in the cylinder axis direction of the outer terminal. That is, the plurality of contact portions are dispersedly disposed in the cylinder axis direction. Accordingly, as compared with a case where all the contact portions are disposed at the same position in the cylinder axis direction, the number of the contact portions maintaining contact with the mating terminal can be increased even when the outer terminal is inclined with respect to the mating terminal. Specifically, for example, even when the first contact portions disposed on the back side of the mating terminal are separated from the mating terminal, the second contact portions disposed on the front side of the mating terminal are maintained in contact with the mating terminal. Therefore, the terminal unit and the connector according to the present disclosure are excellent in reliability of electrical connection with the mating terminal unit and the mating connector.

The present disclosure has been briefly described above. Details of the present disclosure will be further clarified by reading modes for carrying out the invention described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a side view illustrating a state where a female connector according to an embodiment of the present disclosure is fitted to a mating male connector;

FIG. 2 is a side view illustrating a female terminal accommodated in the female connector illustrated in FIG. 1;

FIG. 3 is a schematic view illustrating a state where the female terminal accommodated in the female connector illustrated in FIG. 1 and a male terminal accommodated in the male connector illustrated in FIG. 1 are connected;

FIG. 4 is a cross-sectional view taken along a line A-A in FIG. 3;

FIG. 5 is a cross-sectional view taken along a line B-B in FIG. 3;

FIG. 6 is a schematic view corresponding to FIG. 3 when the female terminal is inclined with respect to the male terminal;

FIG. 7 is a cross-sectional view taken along a line C-C in FIG. 6; and

FIG. 8 is a cross-sectional view taken along a line D-D in FIG. 6.

### DETAILED DESCRIPTION OF THE INVENTION

### Embodiment

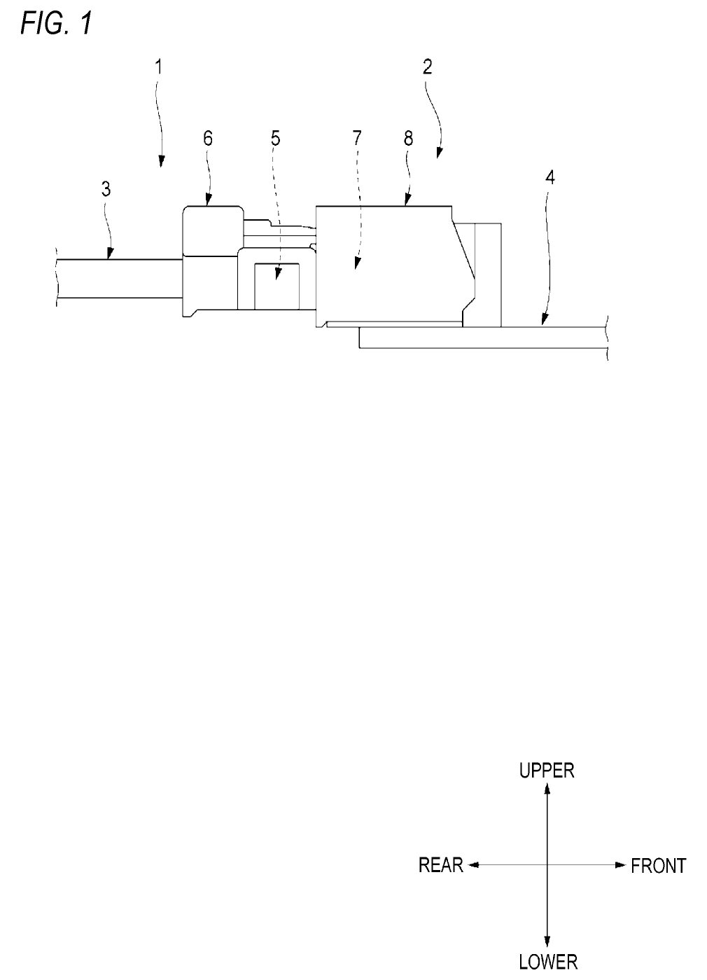

Hereinafter, a female connector 1 according to an embodiment of the present disclosure will be described with reference to the drawings. As illustrated in FIG. 1, a female housing 6 of the female connector 1 can be fitted to a male housing 8 of a male connector 2. The female connector 1 is a connector used in a coaxial cable 3 that transmits a high-frequency signal or the like. The male connector 2 is a connector mounted on a circuit substrate 4, and is also called a printed circuit board (PCB) connector.

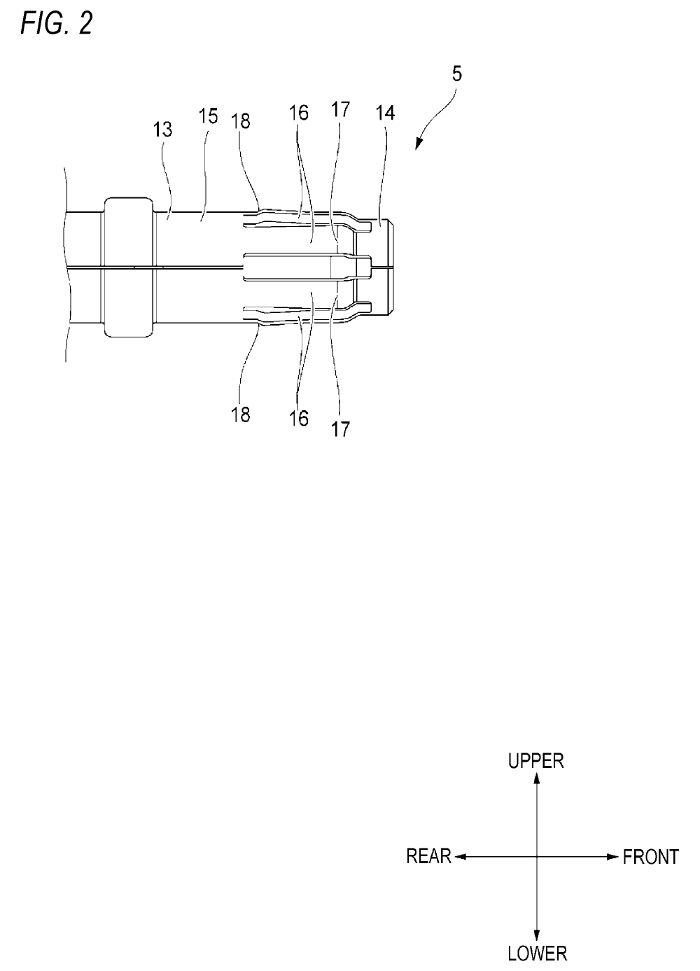

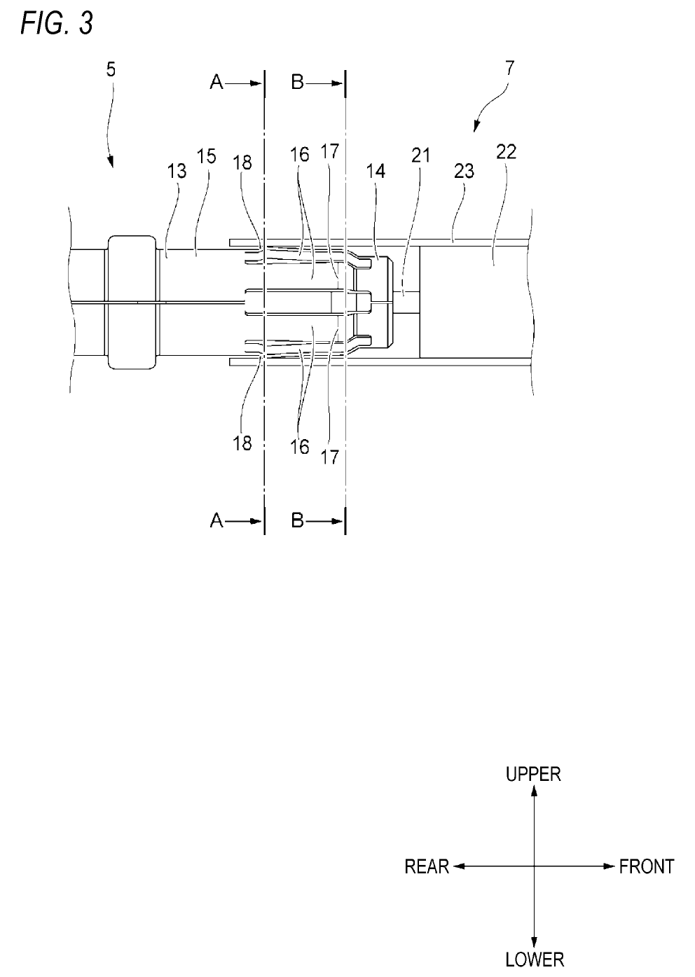

As illustrated in FIG. 1, when the female connector 1 (the female housing 6) and the male connector 2 (male housing 8) are fitted to each other, a female terminal 5 (see FIGS. 2 and 3) accommodated in the female housing 6 and a male terminal 7 (see FIG. 3) accommodated in the male housing 8 are electrically connected to each other, and the coaxial cable 3 connected to the female terminal 5 and the circuit substrate 4 connected to the male terminal 7 are electrically connected to each other. Each of the female connector 1 and the male connector 2 has a shielding function for preventing leakage of electromagnetic waves caused by signals transmitted by the coaxial cable 3 and intrusion of electromagnetic waves from an outside. Here, the female connector 1 corresponds to a “connector” in the present disclosure, the female housing 6 corresponds to a “housing” in the present disclosure, the female terminal 5 corresponds to a “terminal unit” in the present disclosure, and the coaxial cable 3 corresponds to a “coaxial electric wire” in the present disclosure.

Hereinafter, for convenience of description, as illustrated in FIGS. 1 to 8, "front", "rear", "upper", "lower", "left", "right", a "front-rear direction", a "left-right direction", and an "upper-lower direction" are defined. The "front-rear direction", the "left-right direction", and the "upper-lower direction" are orthogonal to one another. The front-rear direction coincides with a fitting direction of the female connector 1 and the male connector 2. The front-rear direction corresponds to a “cylinder axis direction” of the present disclosure. With respect to the front-rear direction, a front side in the fitting direction as viewed from the female connector 1 is referred to as a front side, and an opposite back side in the fitting direction is referred to as a rear side.

First, the male connector 2 will be described. As illustrated in FIG. 1, the male connector 2 includes the male terminal 7 (see also FIG. 3), the circuit substrate 4 on which the male terminal 7 is mounted, and the male housing 8 that accommodates the male terminal 7 and is fixed to the circuit substrate 4. The male housing 8 is a resin molded body. The male terminal 7 is accommodated in a terminal accommodating chamber (not illustrated) provided in the male housing 8.

As illustrated in FIG. 3, the male terminal 7 has a shape extending in the front-rear direction, and includes an elongated cylindrical metal male inner terminal 21, a thick cylindrical insulator 22 covering an outer periphery of the male inner terminal 21, and a thin cylindrical metal male outer terminal 23 covering an outer periphery of the insulator 22. In this way, the male inner terminal 21 is disposed inside a cylinder of the male outer terminal 23.

The male inner terminal 21 is electrically connected to a signal processing circuit (not illustrated) formed on the circuit substrate 4, and the male outer terminal 23 is electrically connected to a ground circuit (not illustrated) formed on the circuit substrate 4. When the female connector 1 and the male connector 2 are fitted to each other, the male inner terminal 21 and the male outer terminal 23 are connected to a female inner terminal 11 and a female outer terminal 13 of the female terminal 5, respectively (see FIG. 3). Here, the female inner terminal 11 corresponds to an “inner terminal” of the present disclosure, the female outer terminal 13 corresponds to a “terminal” and an “outer terminal” of the present disclosure, and the male outer terminal 23 corresponds to a “mating terminal” of the present disclosure.

Next, the female connector 1 will be described. As illustrated in FIG. 1, the female connector 1 includes the female terminal 5, the coaxial cable 3 electrically connected to the female terminal 5, and the female housing 6 for accommodating the female terminal 5. The female housing 6 is a resin molded body. The female terminal 5 is accommodated in a terminal accommodating chamber (not illustrated) provided in the female housing 6.

The coaxial cable 3 includes, for example, a rod-shaped conductor core wire (an inner conductor), a cylindrical inner insulator covering an outer periphery of the conductor core wire, a cylindrical braided conductor (an outer conductor) covering an outer periphery of the inner insulator, and a cylindrical outer insulator (a sheath) covering an outer periphery of the braided conductor (not illustrated).

As illustrated in FIGS. 2 to 5, the female terminal 5 has a shape extending in the front-rear direction, and includes the thin cylindrical metal female inner terminal 11, a thick cylindrical resin insulator 12 covering an outer periphery of the female inner terminal 11, and the thin cylindrical metal female outer terminal 13 covering an outer periphery of the insulator 12. In this way, the female inner terminal 11 is disposed inside a cylinder of the female outer terminal 13. The female inner terminal 11 is electrically connected (conductively connected) to the conductor core wire of the coaxial cable 3, and the female outer terminal 13 is electrically connected (conductively connected) to the braided conductor of the coaxial cable 3.

More specifically, as illustrated in FIGS. 2 and 3, the female outer terminal 13 has a stepped cylindrical shape including a small-diameter portion 14 constituting a tip end portion (a front end portion) of the female outer terminal 13 and a large-diameter portion 15 located on a base end side (on the rear side) relative to the small-diameter portion 14 and having a larger diameter than that of the small-diameter portion 14. On an outer peripheral surface of the female outer terminal 13, a plurality of (six in the present embodiment) plate spring portions 16 extending in the front-rear direction in an elongated plate shape to straddle the small-diameter portion 14 and the large-diameter portion 15 are provided to be arranged at equal intervals in a peripheral direction of the female terminal 5. Each plate spring portion 16 constitutes a part of the outer peripheral surface of the female outer terminal 13.

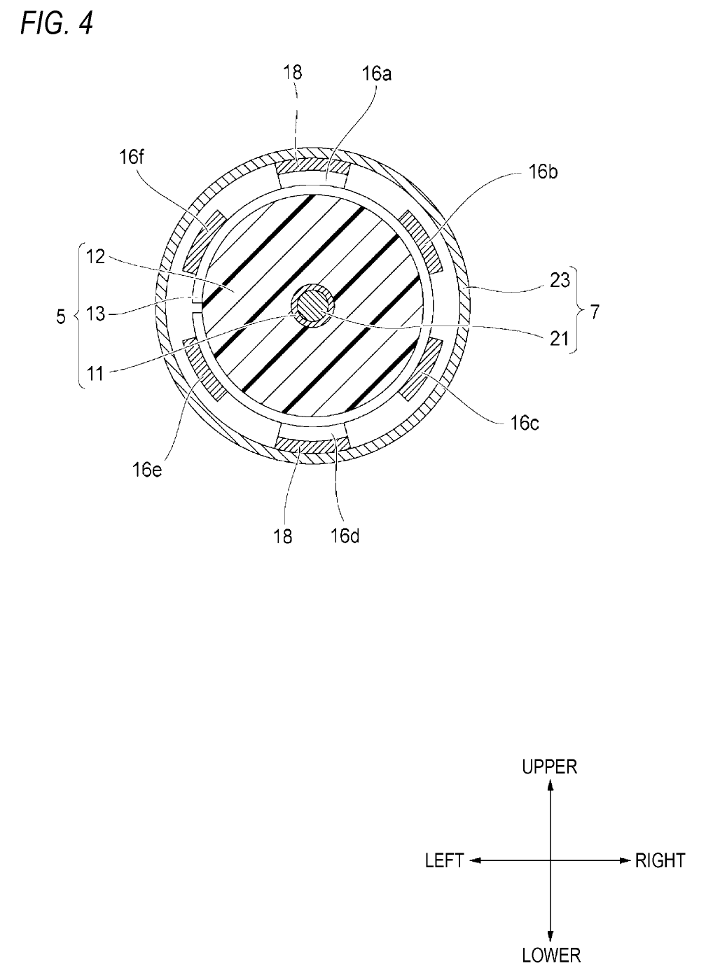

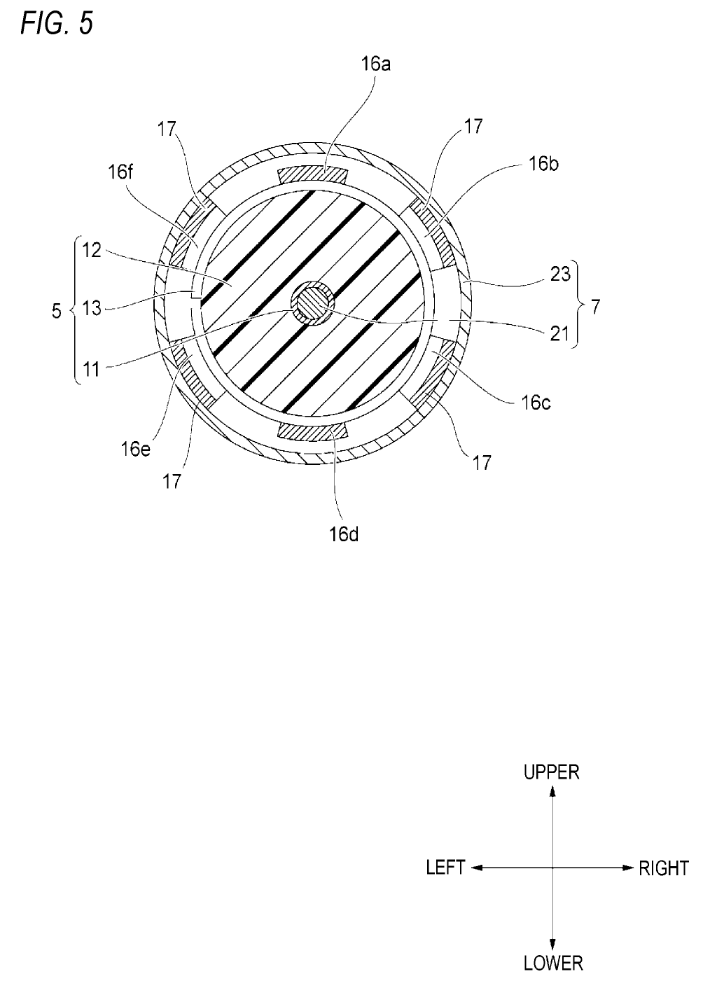

Each of the plate spring portions 16 has a double-supported beam shape in which one end portion in the front-rear direction is connected to the small-diameter portion 14 and the other end portion in the front-rear direction is connected to the large-diameter portion 15. A slit extending in the front-rear direction is provided between the plate spring portions 16 adjacent to each other in the peripheral direction of the female terminal 5. In other words, each plate spring portion 16 is elastically deformable in a radial direction of the female terminal 5. Each plate spring portion 16 is formed by providing the slits extending in the front-rear direction at both end edges in a width direction (the peripheral direction of the female terminal 5) in a region of the female outer terminal 13 that corresponds to the plate spring portion 16. Hereinafter, for convenience of description, each of the six plate spring portions 16 may be referred to as plate spring portions 16a, 16b, 16c, 16d, 16e, and 16f as illustrated in FIGS. 4 and 5.

As illustrated in FIGS. 3 to 5, the six plate spring portions 16a to 16f include the plate spring portions 16 each provided with a first contact portion 17 (and not provided with a second contact portion 18) and the plate spring portions 16 each provided with the second contact portion 18 (and not provided with the first contact portion 17). In this example, the first contact portion 17 is provided on each of the four plate spring portions 16b, 16c, 16e, and 16f (see FIG. 5), and the second contact portion 18 is provided on each of the two plate spring portions 16a and 16d (see FIG. 4). As illustrated in FIGS. 3 and 5, the first contact portion 17 is a protrusion that is provided at a position (a first position) on a tip end side (a front end side) of the plate spring portion 16 in the front-rear direction and is curved to protrude outward in the radial direction of the female terminal 5. As illustrated in FIGS. 3 and 4, the second contact portion 18 is a protrusion that is provided at a position (a second position) on a base end side (a rear end side) of the plate spring portion 16 in the front-rear direction and is curved to protrude outward in the radial direction of the female terminal 5. The first contact portion 17 provided at the first position of the plate spring portion 16 is disposed on a front side (a back side of the male terminal 7) relative to the second contact portion 18 provided at the second position of the plate spring portion 16.

In this way, the first contact portion 17 and the second contact portion 18 are disposed at different positions in the cylinder axis direction (the front-rear direction) of the female terminal 5 and are disposed at different positions in the peripheral direction of the female terminal 5. The number (four) of the first contact portions 17 disposed on the back side of the male terminal 7 relative to the second contact portions 18 is larger than the number (two) of the second contact portions 18.

As illustrated in FIGS. 3 to 5, when the female connector 1 and the male connector 2 are normally fitted to each other, that is, when the female terminal 5 and the male terminal 7 are concentrically disposed and connected to each other, the male inner terminal 21 is inserted into a cylinder of the female inner terminal 11, thereby electrically connecting (conductively connecting) the male inner terminal 21 and the female inner terminal 11, and the female outer terminal 13 is inserted into a cylinder of the male outer terminal 23 and the first contact portion 17 of each of the four plate spring portions 16b, 16c, 16e, and 16f and the second contact portion 18 of each of the two plate spring portions 16a and 16d elastically come into contact (press contact) with an inner peripheral surface of the male outer terminal 23, thereby electrically connecting (conductively connecting) the male outer terminal 23 and the female outer terminal 13.

In this way, in the female outer terminal 13, the four first contact portions 17 and the two second contact portions 18 are in contact with the male outer terminal 23. In other words, four positions at the first position and two positions of the plate spring portion 16 at the second position (six positions in total) of the plate spring portion 16 are in contact with the male outer terminal 23.

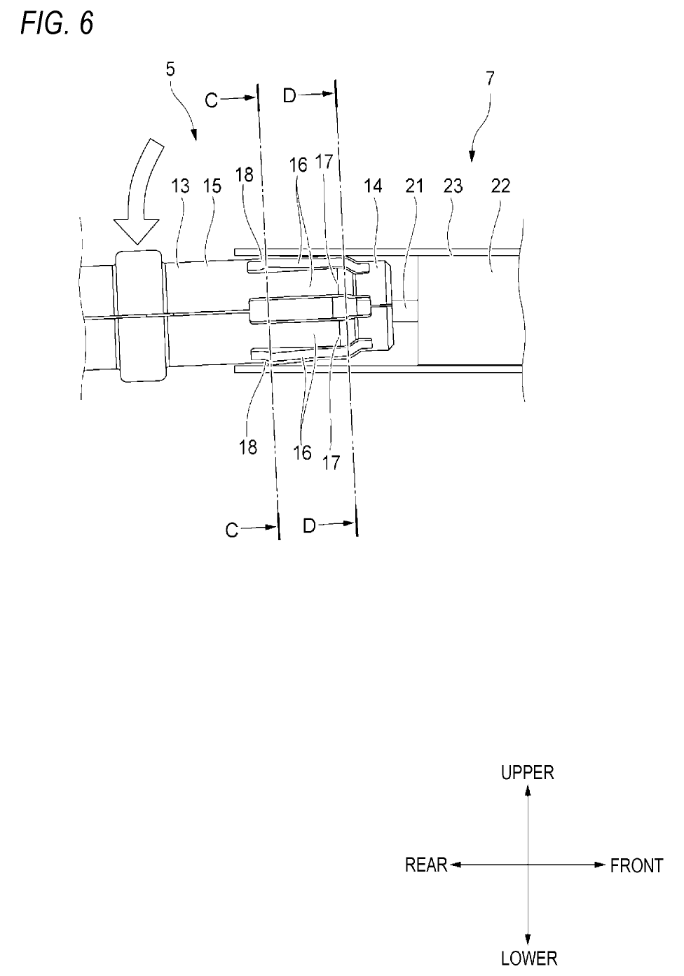

Hereinafter, as illustrated in FIGS. 3 to 5, in a state where the female terminal 5 and the male terminal 7 are concentrically disposed and connected to each other, it is assumed that the female terminal 5 is inclined with respect to the male terminal 7 as indicated by a white arrow in FIG. 6 due to an external force applied to the coaxial cable 3 as in examples illustrated in FIGS. 6 to 8.

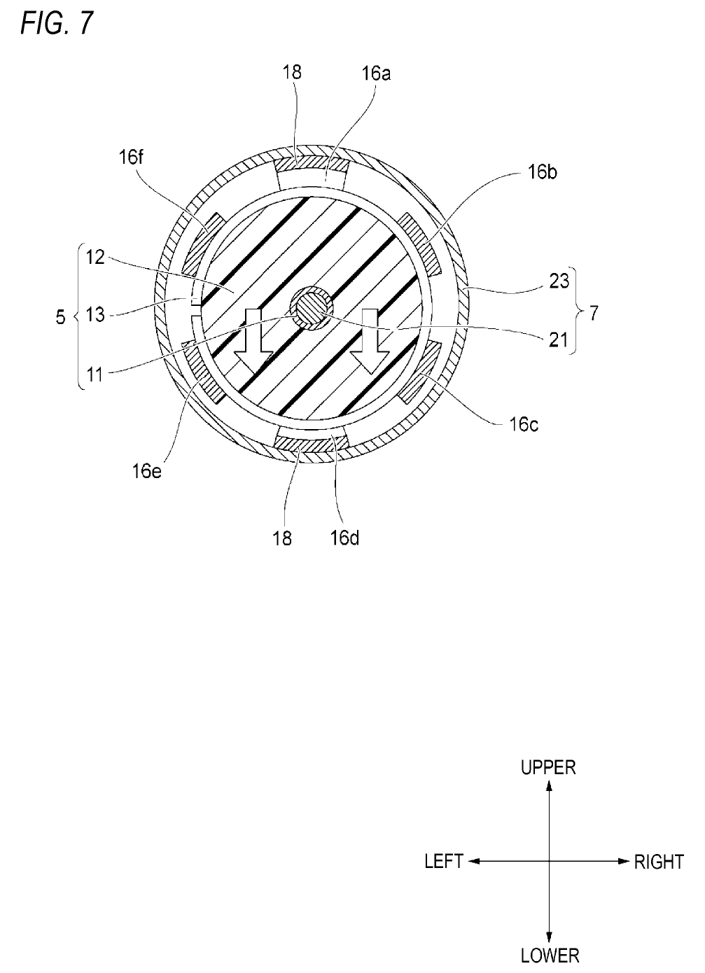

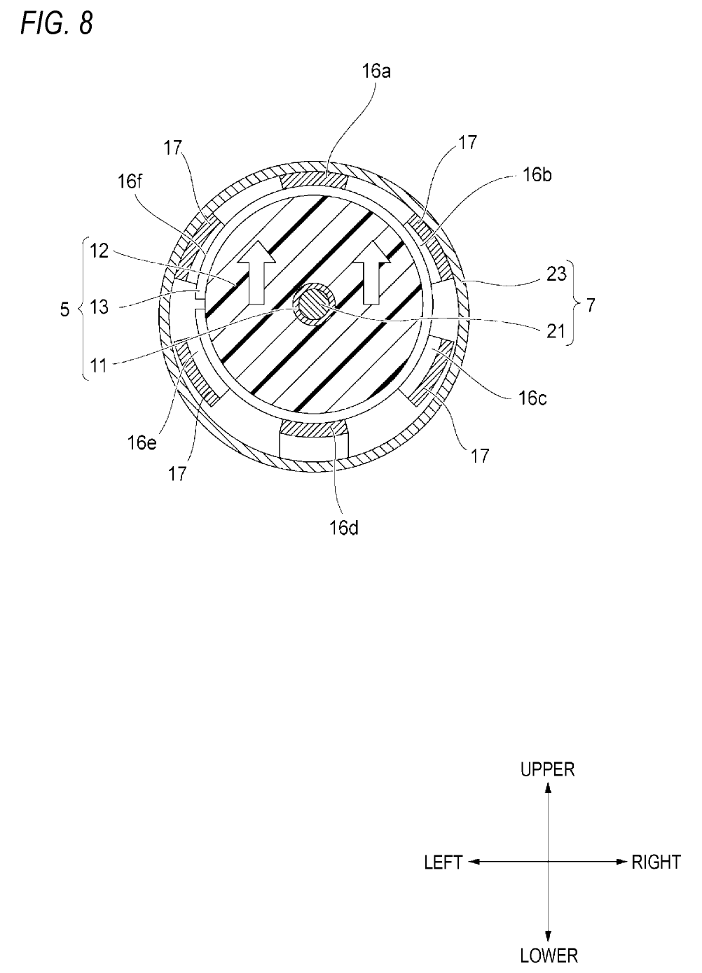

In this regard, as in the examples illustrated in FIGS. 6 to 8, in the present embodiment, at the first position of the plate spring portion 16, as illustrated in FIG. 8, the first contact portions 17 of the two plate spring portions 16c and 16e are separated from the male outer terminal 23 by an upward displacement of the female terminal 5, while the first contact portions 17 of the two plate spring portions 16b and 16f still continue to be in contact with the male outer terminal 23, and further, the plate spring portion 16a without the first contact portions 17 newly comes into contact with the male outer terminal 23. At the second position of the plate spring portion 16, as illustrated in FIG. 7, the female terminal 5 is displaced downward, but the second contact portions 18 of the two plate spring portions 16a and 16d still continue to be in contact with the male outer terminal 23. In other words, in the female outer terminal 13, three positions in the first position of the plate spring portion 16 and two positions in the second position of the plate spring portion 16 (five positions in total) are in contact with the male outer terminal 23.

In this way, in the present embodiment, since the first contact portions 17 and the second contact portions 18 are dispersedly disposed in the cylinder axis direction of the female terminal 5, even when a part of the plurality of first contact portions 17 disposed on the back side of the male terminal 7 are separated from the male outer terminal 23, the second contact portions 18 disposed on a front side of the male terminal 7 are maintained in contact with the male outer terminal 23. Therefore, for example, as compared with a case where the first contact portions 17 are provided (and the second contact portion 18 is not provided) in all of the six plate spring portions 16, even when the female terminal 5 is inclined with respect to the male terminal 7, it is possible to reduce a decrease in the number of portions in contact with the male outer terminal 23. As a result, it is easy to prevent the impedance of the conductive path (a ground circuit) including the female outer terminal 13 and the male outer terminal 23 from greatly deviating from a design value.

In the present embodiment, since the first contact portions 17 and the second contact portions 18 are dispersedly disposed in the peripheral direction of the female terminal 5, even when the female terminal 5 is inclined in various directions in the peripheral direction, the number of portions in contact with the male outer terminal 23 can be increased. When the female terminal 5 is inclined with respect to the male terminal 7, it is considered that the first contact portion 17 disposed on a front side (the back side of the male terminal 7) relative to the second contact portion 18 is more easily separated from the male outer terminal 23 than the second contact portion 18, but in the present embodiment, since the number of the first contact portions 17 is larger than the number of the second contact portions 18, even when the female terminal 5 is inclined, the number of portions in contact with the male outer terminal 23 can be increased.

### Operations and Effects

As described above, according to the female connector 1 (the connector), the female terminal 5 (the terminal unit), and the female outer terminal 13 (the terminal) according to the present embodiment, a plurality of contact portions (the first contact portions 17 and the second contact portions 18) of the terminal (the female outer terminal 13) protrude toward the mating terminal (the male outer terminal 23), and are elastically in contact with the mating terminal 23 when the terminal 13 and the mating terminal 23 are connected. The plurality of contact portions include the first contact portions 17 and the second contact portions 18 disposed at different positions in the cylinder axis direction of the terminal 13. That is, the plurality of contact portions 17 and 18 are dispersedly disposed in the cylinder axis direction. Accordingly, as compared with a case where all the contact portions are disposed at the same position in the cylinder axis direction, the number of the contact portions 17 and 18 maintaining contact with the mating terminal 23 can be increased even when the terminal 13 is inclined with respect to the mating terminal 23. For example, even when the first contact portions 17 disposed on the back side of the mating terminal 23 are separated from the mating terminal 23, the second contact portions 18 disposed on the front side of the mating terminal 23 are maintained in contact with the mating terminal 23. Therefore, the connector 1, the terminal unit 5, and the terminal 13 according to the present embodiment are excellent in reliability of electrical connection with the mating terminal 23.

As another effect, since the plurality of contact portions 17 and 18 provided in the terminal 13 are dispersedly disposed in the cylinder axis direction, when the terminal 13 is connected to the mating terminal 23 while being brought close to the mating terminal 23, the respective contact portions 17 and 18 sequentially come into contact with the mating terminal 23. Therefore, it is possible to prevent a rapid increase in a force (a so-called insertion force) required to bring the terminal 13 close to the mating terminal 23 as compared with a case where the plurality of contact portions 17 and 18 simultaneously come into contact with the mating terminal 23. As a result, workability of work of connecting the terminal 13 and the mating terminal 23 can be improved.

According to the terminal 13 of the present embodiment, the first contact portions 17 and the second contact portions 18 are disposed at different positions in the peripheral direction of the terminal 13. Accordingly, the first contact portions 17 and the second contact portions 18 are dispersedly disposed in the peripheral direction. Accordingly, even when the terminal 13 is inclined in various directions in the peripheral direction, the number of contact portions 17 and 18 maintaining contact with the mating terminal 23 can be increased.

According to the terminal 13 of the present embodiment, the first contact portions 17 are configured to be disposed on the back side of the mating terminal 23 relative to the second contact portions 18, and the number of first contact portions 17 is larger than the number of second contact portions 18. Accordingly, since the number of first contact portions 17 that are likely to be separated from the mating terminal 23 when the terminal 13 is inclined with respect to the mating terminal 23 is large, the number of contact portions 17 and 18 maintaining contact with the mating terminal 23 when the terminal 13 is inclined can be increased.

### Other Aspects

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

In the embodiment described above, the first contact portions 17 and the second contact portions 18 are disposed at different positions in the peripheral direction of the female terminal 5 (that is, provided in the plate spring portions 16 different from each other), and there is no plate spring portion 16 provided with both the first contact portion 17 and the second contact portion 18. In contrast, there may be one or more plate spring portions 16 provided with both the first contact portion 17 and the second contact portion 18. In other words, there may be one or more pairs of the first contact portion 17 and the second contact portion 18 disposed at the same position in the peripheral direction of the female terminal 5.

In the embodiment described above, the first contact portions 17 and the second contact portions 18 are provided on the female outer terminal 13, and these contact portions are not provided on the male outer terminal 23. In contrast, the first contact portions 17 and the second contact portions 18 may be provided on the male outer terminal 23, and these contact portions may not be provided on the female outer terminal 13. The first contact portions 17 and the second contact portions 18 may be provided on both the female outer terminal 13 and the male outer terminal 23.

In the embodiment described above, the number of first contact portions 17 disposed on the back side of the male terminal 7 relative to the second contact portions 18 is larger than the number of second contact portions 18. In contrast, the number of first contact portions 17 disposed on the back side of the male terminal 7 relative to the second contact portions 18 may be the same as the number of second contact portions 18 or may be less than the number of second contact portions 18.

Here, features of the connector 1, the terminal unit 5, and the terminal 13 according to the embodiment of the present disclosure described above are briefly summarized and listed in the following [1] to [5].

[1]

A terminal (13) having a tubular shape, the terminal (13) including:

a plurality of contact portions (17 and 18) protruding toward a mating terminal (23) on a peripheral surface of the terminal to face the mating terminal (23), in which

the plurality of contact portions (17 and 18) are elastically deformable in a protruding direction toward the mating terminal (23), and include a first contact portion (17) and a second contact portion (18) disposed at different positions in a cylinder axis direction of the terminal (13).

According to the terminal of the above configuration [1], the plurality of contact portions provided in the terminal protrude toward the mating terminal and are in elastically contact with the mating terminal when the terminal and the mating terminal are connected. The plurality of contact portions include the first contact portion and the second contact portion disposed at different positions in the cylinder axis direction of the terminal. That is, the plurality of contact portions are dispersedly disposed in the cylinder axis direction. Accordingly, as compared with a case where all the contact portions are disposed at the same position in the cylinder axis direction, the number of the contact portions maintaining contact with the mating terminal can be increased even when the terminal is inclined with respect to the mating terminal. Specifically, for example, even when the first contact portions disposed on the back side of the mating terminal are separated from the mating terminal, the second contact portions disposed on the front side of the mating terminal are maintained in contact with the mating terminal. As understood from the present description, the tubular surface of the terminal on which the plurality of contact portions are provided may be an outer tubular surface or an inner tubular surface depending on a positional relationship between the terminal and the mating terminal. In this way, the terminal having this configuration is excellent in reliability of electrical connection with the mating terminal.

As another effect, since the plurality of contact portions provided in the terminal are dispersedly disposed in the cylinder axis direction, when the terminal is connected to the mating terminal while being brought close to the mating terminal, the respective contact portions sequentially come into contact with the mating terminal. Therefore, it is possible to prevent a rapid increase in a force (a so-called insertion force) required to bring the terminal close to the mating terminal as compared with a case where the plurality of contact portions simultaneously come into contact with the mating terminal. As a result, workability of work of connecting the terminal and the mating terminal can be improved.

[2]

The terminal (13) according to [1], in which

the first contact portion (17) and the second contact portion (18) are disposed at different positions in a peripheral direction of the terminal (13).

According to the terminal of the above configuration [2], the first contact portion and the second contact portion are disposed at different positions in the peripheral direction of the terminal. Accordingly, the first contact portion and the second contact portion are dispersedly disposed in the peripheral direction. Accordingly, even when the terminal is inclined in various directions in the peripheral direction, the number of contact portions maintaining contact with the mating terminal can be increased.

[3]

The terminal (13) according to [1], in which

the plurality of contact portions (17 and 18) are implemented such that, when the terminal (13) and the mating terminal (23) are connected to each other, the first contact portion (17) is disposed on a back side of the mating terminal (23) relative to the second contact portion (18), and the number of the first contact portions (17) is larger than the number of the second contact portions (18).

According to the terminal of the above configuration [3], the first contact portions are configured to be disposed on the back side of the mating terminal relative to the second contact portions, and the number of first contact portions is larger than the number of second contact portions. Accordingly, since the number of first contact portions that are likely to be separated from the mating terminal when the terminal is inclined with respect to the mating terminal is large, the number of contact portions maintaining contact with the mating terminal when the terminal is inclined can be increased.

[4]

A terminal unit (5) including:

the terminal (13) according to any one of [1] to [3] as an outer terminal (13);

an inner terminal (11) disposed in a cylinder of the outer terminal (13); and

an insulator (12) disposed between the outer terminal (13) and the inner terminal (11).

[5]

A connector (1) including:

the terminal unit (5) according to [4];

a coaxial electric wire (3) electrically connected to the terminal unit (5); and

a housing (6) accommodating the terminal unit (5).

According to the terminal unit of the configuration [4] and the connector of the configuration [5], the plurality of contact portions provided in the outer terminal protrude toward the mating terminal and are elastically in contact with the mating terminal when the outer terminal and the mating terminal are connected. The plurality of contact portions include a first contact portion and a second contact portion disposed at different positions in a cylinder axis direction of the outer terminal. That is, the plurality of contact portions are dispersedly disposed in the cylinder axis direction. Accordingly, as compared with a case where all the contact portions are disposed at the same position in the cylinder axis direction, the number of the contact portions maintaining contact with the mating terminal can be increased even when the outer terminal is inclined with respect to the mating terminal. For example, even when the first contact portions disposed on the back side of the mating terminal are separated from the mating terminal, the second contact portions disposed on the front side of the mating terminal are maintained in contact with the mating terminal. Therefore, the terminal unit and the connector of the present configuration are excellent in reliability of electrical connection with the mating terminal unit and the mating connector.

1. A terminal having a tubular shape, the terminal comprising:
a plurality of contact portions protruding toward a mating terminal on a tubular surface of the terminal to face the mating terminal, wherein
the plurality of contact portions are elastically deformable in a protruding direction toward the mating terminal, and include a first contact portion and a second contact portion disposed at different positions in a cylinder axis direction of the terminal.

2. The terminal according to claim 1, wherein
the first contact portion and the second contact portion are disposed at different positions in a peripheral direction of the terminal.

3. The terminal according to claim 1, wherein
the plurality of contact portions are implemented such that, when the terminal and the mating terminal are connected to each other, the first contact portion is disposed on a back side of the mating terminal relative to the second contact portion, and the number of the first contact portions is larger than the number of the second contact portions.

4. A terminal unit comprising:
the terminal according to claim 1 as an outer terminal;
an inner terminal disposed in a cylinder of the outer terminal; and
an insulator disposed between the outer terminal and the inner terminal.

5. A connector comprising:
the terminal unit according to claim 4;
a coaxial electric wire electrically connected to the terminal unit; and
a housing accommodating the terminal unit.
